(19) United States
(12) Patent Application Publication
(10) Pub. No.: US 2004/0127363 A1
(43) Pub. Date: Jul. 1, 2004

(54) Pesticidal compositions containing silicon compounds

(76) Inventors: Josef Guzman, Katzerin (IL); Asaf Paz, Beit Hillel (IL); Yoram Tsivion, Pardess Hanna (IL)

Correspondence Address: Nath & Associates, Sixth Floor, 1030 15th Street NW, Washington, DC, 20005, US

(21) Appl. No.: 10/471,637

(22) PCT Filed: Mar. 15, 2001
(86) PCT No.: PCT/IL01/00251

(30) Foreign Application Priority Data
Mar. 15, 2000 (IL) 135092

(51) Int. Cl. A01N 55/08

(52) U.S. Cl. 504/193

(57) ABSTRACT

The present invention deals with pesticidal compositions comprising as the active component a silicon ester of formula (I), and a method for controlling insects, mites, nematodes and fungi, by the application of such a composition. The invention is further directed to a method for the preparation silicon esters of formula (I) and some such novel compounds.

### FIELD OF THE INVENTION

The present invention relates to silicon esters and to their application for the control of pests.

### BACKGROUND OF THE INVENTION

Various types of pesticides are known in the art. They are either synthetic or derived from natural products. The active pesticides are usually applied in the form of specific formulations each designed for a predetermined use. Thus pesticides may be dissolved or emulsified in aqueous or other hydrophilic solutions or may be dissolved in organic solutions together with appropriate additives. They may be dispersed or applied as dust. Surfactants play an important role in many of commonly used pesticidal formulations used in household or in the field.

Most chemical pesticides are inherently toxic and efforts to minimize their residual environmental are constantly being made. One approach is to design biodegradable pesticide, which will be disintegrated biochemically into non-hazardous entities, provided their hydrolysis products are nontoxic. Introducing labile groups into active pesticide compounds facilitating their future breakdown is a rather known approach.

EP 249,015 and EP 224,024 disclose pesticides containing a silicon moeity such as (4-ethoxyphenyl)-(dimethyl)-silane. U.S. Pat. No. 5,026,874 discloses yet another family of pesticides, which may comprise a silyl group.

Silicon containing compounds having at least one hydrolyzable Si—O—C bond Kirk-Othmer Encyclopedia of Chemical Technology 4^{th} edition, Vol. 22, pages 31-142) are known as biodegradable compounds having very low LD₅₀ values. These compounds are frequently used as catalysts for concrete hardening, silanization agents in textile and surfactants. U.S. Pat. Nos. 4,282,207 and 4,500,339, for example, disclose use of such hydrolyzable silicon compounds as slow release carriers for pesticides and microbiocides. It is also a fact of pesticide activities of halogenated phenoxysilanes (U.S. Pat. No. 3,546,267), some non-substituted phenyl alkoxysilanes (EP 0152852), alkyl alkoxysilanes (EP 0152852 and JP59/016,811), and tetra alkoxysilanes or their condensation products (EP 0152852). Furthermore, pesticide properties are inherent in silicon containing compounds chosen from the group consisting of siloxane-glycol and siloxane-alkylene oxide copolymers (EP 0191 543, WO 01/19190 A1 and U.S. Pat. No. 4,656,162). These copolymers may contain also (poly)oxyalkylene group substituted with “monovalent hydrocarbyl group selected from the group consisting of alkyl, cycloalkyl, alkenyl,aryl and aralkyl, or an acyl group” (U.S. Pat. No. 4,656,162). EP 249,015 and EP 224,024 disclose pesticides containing a silicon moiety such as (4-ethoxyphenyl)-(dimethyl)silane. U.S. Pat. No. 5,026,874 discloses yet another family of pesticides, which may comprise a silyl group. There are many stable organosilicon compounds in prior art, for example polysiloxanes of PCT WO 01/19190 A1, and EP249015B1.

### SUMMARY OF THE INVENTION

There is accordingly a need in the art to find more environmentally friendly pesticides and pesticide formulations in order to decrease the hazardous consequences of pesticide applications.

The present invention thus provides a pesticidal composition comprising as the active component a silicon ester compound of formula (I) for use in the control of pests, more specifically, for the control of insects, mites, nematodes and fungi:

R¹_{A}(R²O)_{B}(R³O)_{C}SiO[R¹_{D}(R⁴O)_{E}R⁵_{F}SiO]_{X}[R¹_{G}R⁵_{P}R⁶_{Q}SiO]_{Y}R⁴ (I)

wherein:

A=0-1 and B, C=0-3 and A+B+C=3;

D=0-1 and E, F=0-2 and D+E+F=2;

G=0-1 and P,Q=0-2 and G+P+Q=2;

X, Y≧0

1. R¹ and R³ may be the same or different and are C₁-C₂₀alkyl or C₆-C₂₀aryl;

2. R² is R(OCₙH₂ₙ)ₘ, n=2-4; m=0-20, wherein R may be:

A). Poly- or per-fluorosubstituted C₁-C₃₀alkyl or C₃-C₃₀alkenyl; or

B). Alkaryl-R′R″—C₆H₃—, where R′ is C₃-C₂₀alkyl, R″═R′; or

C). Nitrogen-containing radical of general formula R′R″NCH₂CH₂—, where R′ is C₁-C₃₀alkyl or C₃-C₃₀alkenyl, including poly-or per-fluoroderivatives; R″ is R′ or H or alkylsulfonyl, R′″SO₂—, where R′″ is C₁-C₃₀alkyl or C₃-C₃₀alkenyl, or its poly-or per-fluoroderivatives; or

D). Heterocyclic moiety selected from the group comprising of (tetahydro)furfuryl, N-pyperidyl- and N-morpholyl- ; or

E). Mono-, di- or oligosaccharide or its derivative; or

F). Polyol monoalkanoate,

3. R⁴ is R² or R³

4. R⁵ is R¹_{A}(R²O)_{B}(R³O)_{C}SiO—

5. R⁶ is R⁵[R¹_{D}(R⁴O)_{E}R⁵_{F}SiO]_{Z}-, Z≧0

provided that

a. the compound comprises at least one silicon atom having at least three Si—O bonds;

b. the compound comprises at least one R² radical.

The composition may comprise the compound of formula (I) alone or together with appropriate additives so as to obtain a useful formulation for the application of the pesticide. The composition may be an aqueous or a non-aqueous solution, which may further comprise surfactants. The amount of the compound of formula (I) in the composition depends on the nature of the formulation and may be in the range of from about 0.03% to about 20% (w) in an aqueous solution and from about 20% to about 99% (w) in a non-aqueous solution. The amount of the added surfactant may be up to about 6 times that of the amount of the compound (I) in the composition.

The invention further provides novel compounds of formula (I).

The invention still further provides a method for the synthesis of the compounds of formula (I) by reaction of the silicon-containing compound of formula (II):

R′ₙX₃₋ₙSi(OSi R′ₙX₂₋ₙ)ₘ X (II)

wherein n=0-2, m=0-100, X=Hal, H, OR′, NR′₂, SR′ wherein R′ is monovalent organic residue;

with a alkylpolyalkylene glycol ether of formula (III)

R(OCₙH₂ₙ)ₘ OH (III),

where R is a monovalent organic residue, n is 2-4 and m is 1-20, or the corresponding sodium or potassium alcoholates of formula (IV): R(OCₙH₂ₙ)ₘOM (M═Na, K), or esters of formula (V):R(OCₙH₂ₙ)ₘOC(O)R′, where R′ is a monovalent hydrocarbon radical, or 1,2-epoxy-derivatives of formula (VI): R(OCₙH₂ₙ)ₘO(CH₂)ₓCH(O)CH₂, wherein x=0-4, such as alcohol alkoxylate glycidyl ethers.

### DETAILED DESCRIPTION OF THE INVENTION

As mentioned above the invention is directed to a pesticidal composition comprising as the active ingredient a silicon compound of formula I. It was found that silicon compounds of formula I which have Si—O—C bonds have pesticidal activity and may thus be used as pesticides, in particluar for the control of insects, mites, nematodes and fungi. Due to the presence of Si—O—C bonds, the silicon compound I may be hydrolyzed by various naturally occurring mechanisms, diminishing the residual risk after its application.

The composition may be an aqueous or a non-aqueous solution, dust, powder, paste and may further comprise at least one additional surfactant. The surfactant may be chosen from the group comprising of ionic, amphoteric or non-ionic surfactant and/or water. Suitable surfactants may be selected from the group comprising of TRITON X 100 (polyoxyethylene(9-10)octylphenyl ether), TWEEN-20 (polyoxyethylene (20) unhydrosorbitane monooleate), Agrimul PG 2062 (C₁₂₋₁₄-alkyl polyglycosides) and Silwet L-77 (ethoxylated heptamethyltrisiloxane). In an aqueous solution pesticidal composition the concentration of the compound of formula I is from about 0.03% to about 20% (w), preferably from about 0.05% to about 5%. In a non-aqueous pesticidal composition, the concentration of the compound of formula I is from about 20% to about 99% (w). The amount of added surfactant may be in the range of from about 0.0001 to about 6 times (w) of the compound of formula I in the composition. Preferably, the ratio is from about 0.0001 to about 2 times (w) of the compound of formula I in the composition.

The amount of added water so as to form the aqueous solution, varies, and depends on the required properties the final formulation is expected to posses. Different amounts of water result in different formulations, which in turn are suitable for different use. Thus the final expected use of the formulation govern the amount of added water.

Synthetic procedures for the synthesis of silicon containing compounds are described in (Kirk-Othmer Encyclopedia of Chemical Technology, 4^{th} edition, Vol. 22, pages 31-142). Moreover, the interaction of oligosilicates with alkylpolyalkylene glycol ethers (with molecular weight more then 500 and R being C₁- C₂₀alkyl) has also been disclosed previously e.g. U.S. Pat. Nos 2,630,446 & 3,967,675 & 4,691,039.

The compounds of general formula I are suitably prepared by the esterification (reactions 1-4) and transesterification reactions (reactions 5 and 6) of silicon-containing compounds of formula (II)

Rₙ(R′O)ₘSiXₚ (II)

wherein n+m+p=4, and n, m≧0; X=Hal, H, OR, NR₂, SR; and R and R′ are monovalent organic residues;

with the corresponding reactant according to any of the following reaction paths:

1. ≡Si—X+HOR→≡Si—OR+HX (X═H, Cl, Br, NR₂, SR)

2. ≡Si—X+NaOR→Si—≡OR+NaX (X═Cl,Br)

3. ≡Si—Cl+1,2-Epoxy-Derivatives→≡Si—OCH₂CH(Cl)R′

4. ≡Si—Cl+(RO)₃CH→≡Si—OR+CHCl₃

5. ≡Si—OR+R′OH→≡Si—OR′+ROH

6. ≡Si—OR+R′COOR″→Si—OR″+R′COOR

(R, R′ and R″ are low- or high molecular weight monovalent organic groups).

According to the present invention the compounds of formula (II) are selected from the group comprising of A) Silicon tetrahalides; B). Alkoxysilanes and products of their partially hydrolysis, alkylolygo-silicates with SiO₂ content more than 20%; C). Alkyl alkoxysilanes, RₙSi(OR′)₄₋ₙ; D).Hydride terminated poly(dimethylsiloxane) H[(CH₃)₂SiO]ₙSi(CH₃(₂H, n=1-50; E). Poly (methylhydrosiloxane) (CH₃)₃SiO [(CH₃)HSiO]ₙSi(CH₃)₃, n=1-50; F). Chlorine terminated poly(dimethylsiloxane) Cl[(CH₃)₂SiO]ₙSi(CH₃)₂Cl, n=1-50; G).Methoxy terminated poly-(dimethylsiloxane) CH₃)[(CH₃)₂SiO]ₙSi(CH₃)₂OCH₃, n=1-50.

The corresponding reactants for interacting with the compounds of general formula (II) are selected from the group comprising of alcohols, including monosubstituted polyalkylene glycols of formula (III)

R(OCₙH₂ₙ)ₘOH (III)

Where R is a monovalent organic residue, n is 2-4 and m is 1-20, or the corresponding sodium or potassium alcoholates of formula (IV): R(OCₙH₂ₙ)ₘOM (M=Na, K), or esters of formula (V):R(OCₙH₂ₙ)ₘOC(O)R′, where R′ is a monovalent hydrocarbon radical, or 1,2-epoxy-derivatives of formula (VI): R(OCₙHₙ)ₘO(CH₂)ₓCH(O)CH₂, wherein x=0-4, i.e alcohol alkoxylate glycidyl is ethers.

Monovalent organic residues R of the compounds of general formula III, IV, V and VI are selected from the group comprising: C₁-C₃₀alkyl; C₃-C₃₀alkenyl; C₇-C₃₀aralkyl; alkaryl R′R″ C₆H₃—, where R′═C₃-C₂₀alkyl, R″═H or R′; Poly- (or per)fluorosubstituted C₁-C₃₀alkyl or C₃-C₃₀ alkenyl or C₇-C₃₀aralkyl or alkaryl R′R″ C₆H₃—, where R′═C₃-C₂₀alkyl, R″═H or R′; Acyl R′CO—, R′═C₁-C₃₀alkyl or C₃-C₃₀alkenyl, or C₇-C₃₀aralkyl including poly- or perfluorosubstituted, linear, branched or cyclic moieties;

R′R″NCH₂CH₂—, where R′═C₁-C₃₀alkyl or C₃-C₃₀alkenyl, including poly-or perfluoroderivatives; R″═R′ or H or alkylsulfonyl, R′″SO₂—, where R′″═C₁-C₃₀alkyl or C₃-C₃₀alkenyl, or its poly-or perfluoroderivatives;

Heterocyclic moiety such as fufuryl, N-pyperidyl- and N-morpholyl-;

Mono-, di- or oligosaccharide or its derivative, for example alkylglycoside or alkanoate;

Polyol monoalkanoate, i.e. anhydrosorbitane monoalkanoate;

Thus, the compounds of general formula (I) are prepared by a one-stage process of esterification (reactions 1-4) or by a two-stage process of transesterification. The transesterification process (reactions 5 and 6) is catalytically implemented providing that the resulting low boiling products are eliminated from the reaction zone during the reaction. This process takes place at temperatures from about 100° C. to 200° C. in the presence of a suitable catalyst, such as a strong nucleophilic agents (sodium or potassium hydrides, hydroxides, amides or alcoholates) or Lewis acids such as tetraalkyltitanates (RO)₄Ti, R standing for lower alkyl . It is preferred to carry out the reaction in the absence of moisture, as the presence of water leads to olygosilicate formation.

The preferred monosubstituted polyalkylene glycols of formula (III) are selected from the group comprising of poly(ethylene glycol) octylphenyl ether, poly(ethylene glycol) nonylphenyl ether, poly(ethylene glycol) methyl ether, diethylene glycol monobuthyl ether, poly(ethylene glycol) methyl glucose ether, poly(ethylene glycol) unhydrosorbitane monooleate, poly(ethylene glycol) unhydrosorbitane monolaurate, poly(ethylene glycol) tallow amine ether, poly(ethylene glycol) cocamine ether, poly(ethylene glycol) tetrahydrofurfuryl ether, poly(ethylene glycol) perfluorooctyl ether, poly(ethylene glycol) 2-[ethyl(perfluorooctyl) sulfonyl] aminoethyl and poly(propylene glycol) methyl glucose ether.

The present invention will now be illustrated with reference to the following non-limiting Examples.

### EXAMPLE 1

Step 1: Preparation of sec-butyloligosilicate by esterification process [based on U.S. Pat. No 3,976,675]:

A 2-liter 3-neck flask with magnetic stirrer, a thermometer, a Liebich condenser and gas outlet, was charged with 456 g (2.68 moles) of silicon tetrachloride and cooled with ice-water bath. A solution of 17.9 g (0.994 moles) water in 892.4 g (12.06 M) sec-butanol (analytical grade) was then added with string over a 2 hour period and the temperature was maintained below 12° C. After the addition of all amounts of butanol-water mixture, reaction mixture was heated under reflux for 0.5 hours until it was homogeneous. The volatile compounds were recovered at a temperature of at least 120° c. and 30 mm of mercury pressure. 580 g of viscous liquid as product were isolated.

Step 2: The transesterification process.

A 1-liter, 3-neck flask equipped with a mechanical stirrer and water cooled Liebich condenser was charged with 257.0 grams of Tergitol NP-10 (Union Carbide) and heated up to 100-110° c. To this there was added potassium hydroxide (2.1 g) and 207.5 g of a product of step 1. The flask was then heated up to 150-160° c. and maintained at this temperature for 2.5 hours. The product was cooled down to 100° C. and 3.0 g of NaHCO₃ were added. After filtration, 430.5 g of viscous composition were obtained.

### Examples 2-33

Table 1 summarizes the various synthetic conditions for preparing the silicon esters of formula I.

TABLE 1
Examples 2-33 of the invention.

| | Step 1 | | | Step 2 | | | | | |
|---|---|---|---|---|---|---|---|---|---|
| | | | H₂O/Si | | | | | | |
| Exam. | | | (M/M) | Alcohol | Si source | Catalyst | Ratio (gr./gr.) | | Time |
| No. | Alcohol | Si source | (*) | (m₁) | (m₂) (**) | (m₃) | m₁:m₂:m₃ | T ° C. | Hrs. |
| 2 | 2-Butanol | SiCl₄ | 0.34 | TNP-10 | Silicate-2 | KOH | 1:0.81:0.0080 | 180 | 2.5 |
| 3 | — | Si(OEt)₄ | 0.75 | TNP-10 | Silicate-3 | (BuO)₄Ti | 1:1.58:0.0010 | 190 | 2 |
| 4 | 2-Propanol | SiCl₄ | 0.90 | TNP-10 | Silicate-4 | (BuO)₄Ti | 1:1.46:0.0012 | 130 | 6 |
| 5 | 2-Butanol | SiCl₄ | 0.55 | TNP-10 | Silicate-5 | NaH | 1:1:0.0007 | 150 | 4 |
| 6 | — | — | — | CA-720 | Silicate-5 | t-BuOK | 1:0.45:0.0035 | 150 | 4 |
| 7 | — | — | — | Fluowet ONT | Silicate-5 | KOH | 1:0.75:0.0011 | 160 | 3 |
| 8 | — | — | — | Fluorad | Silicate-5 | KOH | 1:0.68:0.0005 | 170 | 3 |
| | | | | FC-760 | | | | | |
| 9 | — | — | — | PEG-2-E | Silicate-5 | NaH | 1:0.85:0.0006 | 160 | 4 |
| | | | | HOSAE | | | | | |
| 10 | — | — | — | PEGTH | Silicate-5 | NaH | 1:0.80:0.0005 | 170 | 4 |
| | | | | FE | | | | | |
| 11 | 2-Butanol | Si(Obu)₄ | 0.55 | Tween-20 | Silicate-11 | NaH | 1:0.45:.0002 | 140 | 4 |
| 12 | 2-Butanol | SiCl₄ | 0.45 | Glucam E-20 | Silicate-12 | NaNH₂ | 1:0.30:0.0012 | 150 | 3 |
| 13 | — | — | — | Glucam P-10 | Silicate-12 | KOH | 1:0.85:0.0030 | 150 | 3 |
| 14 | — | — | — | Berol-392 | Silicate-12 | NaNH₂ | 1:0.50:0.0010 | 155 | 4 |
| 15 | — | — | — | Berol-397 | Silicate-12 | NaOH | 1:1.15:0.0012 | 160 | 3.5 |
| 16 | 2-Propanol | Si(Oet)₄ | 0.45 | CMPEG-450 | Silicate-16 | KOH | 1:0.80:0.030 | 170 | 2.5 |
| 17 | 1-Propanol | Si(Oet)₄ | 0.20 | POE(10) | Silicate-17 | KOH | 1:0.68:0.0022 | 160 | 3.5 |
| | | | | laurate | | | | | |
| 18 | 2-Propanol | ES-40 | — | POE(16) | Silicate-18 | KOH | 1:0.70:0.0034 | 160 | 3.5 |
| | | | | laurate | | | | | |
| 19 | 2-Butanol | L-31 | — | TNP-10 | Silicate-19 | KOH | 1:0.50:0.0012 | 180 | 2 |
| 20 | 2-Propanol | RH-68 | — | CMPEG-450 | Silicate-20 | NaH | 1:0.40:0.0003 | 180 | 3 |
| 21 | — | — | — | CA-720 | PDMSH | NaH | 1:0.93:0.0003 | 120 | 4 |
| 22 | — | — | — | CA-720 | Si(OBu)₄ | KOH | 1:0.60:0.0011 | 170 | 4 |
| 23 | — | — | — | TNP-10 | MeSi(OEt)₃ | NaH | 1:0.54:0.0005 | 120 | 5 |
| 24 | 2-Butanol | RH-68 | — | TNP-10 | Silicate 24 | KOH | 1:0.51:0.0006 | 165 | 4 |
| 25 | — | — | — | TNP-10 | HMTS | KOH | 1:0.33:0.0006 | 110 | 2 |
| 26 | — | — | — | Glucam E-10 | HMTS | NaH | 1:0.34:0.0005 | 110 | 2 |
| 27 | — | — | — | Glucam E-20 | HMTS | NaH | 1:0.21:0.0006 | 110 | 2 |
| 28 | — | — | — | TNP-10 | ES-40 | KOH | 1:0.58:0.0005 | 165 | 4 |
| 29 | — | — | — | Butylcarbitol | RH-68 | KOH | 1:0.64:0.0005 | 110 | 2 |
| 30 | — | — | — | Cyclohexanol | RH-68 | KOH | 1:0.75:0.0005 | 100 | 2 |
| 31 | — | — | — | 2-Butanol | RH-68 | KOH | 1:0.68:0.0005 | 85 | 2 |
| 32 | — | — | — | Gadsol | L-31 | KOH | 1:1.15:0.0005 | 50 | 3 |
| 33 | — | — | — | 2-Butanol | RH-68 | KOH | 1:1.26:0.0005 | 65 | 3 |

List of Abbreviations used:
1. (*)- ratio mole/mole;
2. POE(n)-polyoxyethylene, POP(n)-polyoxypropylene, (n)-number of links in polyoxyalkylene chain; (**)-Silicate (n)-this silicate was received in the step 1 of example No (n).
3. TNP-10: Tergitol-NP-10 (Union Carbide)-POE(10) nonylphenyl ether;
4. CA-720: Igepal-CA-720 (Rhone-Poulenc France); POE (12) octylphenyl ether
5. Fluowet ONT-(Hoechst Celanese/Colorant & Surf.)-ethoxylated perfluorol;
6. Fluorad FC-760-(3M/Industrial Chem. Prod.)-Fluorinated alkyl alkoxylates;
7. PEG-2-EHOSAE-(Aldrich cat No. 46-818-5)-poly(ethylene glycol)2-[ethyl(heptadecafluorooctyl)sulfonyl]aminoethyl;

List of Abbreviations used:

1. (*)—ratio mole/mole;

2. POE(n)—polyoxyethylene, POP(n)—polyoxypropylene, (n)—number of links in polyoxyalkylene chain; (**)—Silicate (n)—this silicate was received in the step 1 of example No (n).

3. TNP-10 : Tergitol—NP-10 (Union Carbide)—POE (10) nonylphenyl ether;

4. CA-720: Igepal—CA-720 (Rhone-Poulenc France); POE (12) octylphenyl ether

5. Fluowet ONT—Hoechst Celanese/Colorant & Surf.)—ethoxylated perfluorol;

6. Fluorad FC-760—(3M/Industrial Chem. Prod.)—Fluorinated alkyl alkoxylates;

7. PEG-2-EHOSAE—(Aldrich cat. No. 46-818-5)-poly(ethylene glycol)2-[ethyl(heptadecafluorooctyl)sulfonyl]aminoethyl;

8. PEGTHFE—(Aldrich cat. No.30-952-4)-poly (ethylene glycol)tetrahydrofurfuril ether.

9. REG-2-EHOSAE—(Aldrich Cat. No. 46-818-5)-poly(ethyleneglycol)2-[ethyl(heptadecafluorooctyl)sulfonyl] aminoethyl;

10. Tween-20(ICI Surf. Belgium)POE (20) unhydrosorbitane monooleate;

11. Glucam E-10 (Amercol)—POE (10) methyl glucose ether

12. Glucam E-20 (Amercol)—POE (20) methyl glucose ether;

13. Glucam P-10 (Amercol)—POP (10) methyl glucose ether;

14. Berol 392 (Berol Nobel AB)—POE (15) tallow amine;

15. Berol 397 (Berol Nobel AB)—POE (15) cocamine;

16. CMPEG 450-Carbowax MPEG—450 (Union Carbide)-POE (8 methyl ether.

17. POE(10) laurate-poly(ethylene glycol) monolaruate Mₙca600 (Aldrich, Cat. No. 46,014-1);

18. POE (16) oleate-poly(ethylene glycol) monooleate Mₙca860 (Aldrich Cat. No. 46,017-6);

19. ES-40 ethyl silicate—40 (SiO₂ content 40%, prepared from tetraehtyl ortho-silicate and water);

20. L-31-(Union Carbide)—Poly(methyl hydrogen siloxane);

21. RH-68-(Rhodia)-Poly(methylhydrogen siloxane);

22. PDMSH—(Aldrich Cat. No. 42,378-5)-Poly (dimethylsiloxane), hydride terminated;

23. HMTS—(Aldrich Cat. No. 37,088-6)—1,1,1,3,5,5,5,-Heptamethyltrisiloxane;

24. Gadsol-(Gadot, Israel)—mixture of ethanol and iso-propanol.

The silicon esters of examples 1-33 and similar compounds, including known compounds such as tetrabutyl ortho silicate were found to posses high pesticidal activity in a variety of application forms. The pesticidal activity was found both in diluted aqueous solutions and in emulsions together with suitable ionic, amphoteric or non-ionic surfactant, or without any solvent.

The pesticidal activity of the silicon esters of the present invention was tested against mites and insects.

### Example 34

Red mites on citrus: Five citrus trees (lemon, tangerine, kumquat and two orange trees) were infected with red mites. Spraying with an aqueous solution of 0.15% of the product of example 20 comprising also 0.5% TRITON-X 100, left no living mite after 5 days. Control trees were still infected at time of inspection.

### Example 35

Red mites and aphids on flowers: Impatiens plants in pots were heavily infected by red mites and by unidentified aphids. Spraying with an aqueous solution of 1.5% of the product of example 1 left no living mite after 5 days. Control plants were still infested by both pests. Mites concealed by web were also killed. No living aphids were observed 5 days after spraying either.

### Example 36

Aphids on banana plants: unidentified aphids infested plants in a banana nursery. The plants were sprayed with an aqueous solution of 0.5% of the product of example 10. After a week, no living mite were observed, while control plants which were unsprayed plants were still infested.

### Example 37

Ants were sprayed with the product of example 31, where an immediate effect of extermination observed.

Although the invention has been described in conjunction with specific embodiments, it is evident that many alternatives and variations will be apparent to those skilled in the art in light of the foregoing description. Accordingly, the invention is intended to embrace all of the alternatives and variations that fall within the spirit and scope of the appended claims.

1. A pesticidal composition comprising as the active component a silicon ester of formula I
R₁_{A}(R²O)_{B}(R³O)_{C}SiO[R¹_{D}(R⁴O)_{E}R⁵_{F}SiO]ₓ[R¹_{G}R⁵_{P}R⁶_{Q}SiO]_{Y}R⁴ I
wherein:
A=0-1 and B, C=0-3 and A+B+C=3;
D=0-1, E, F=0-2 and D+E+F=2;
G=0 -1 and P, Q=0-2 and G+P+Q=2;
X, Y≧0
1. R¹ and R³ may be the same or different and are C₁-C₂₀alkyl or C₆-C₂₀aryl;
2. R² is R(OCₙH₂ₙ)ₘ, n=2-4; m=0-20 wherein R may be:
A) Poly- or per-fluorosubstituted C₁-C₃₀alkyl or C₃-C₃₀alkenyl; or
B) Alkaryl-R′R′″-C₆H₃—, where R′ is C₃-C₂₀alkyl, R″═R′; or
C) Nitrogen-containing radical of general formula R′R″NCH₂CH₂—, where R′ is C₁-₃₀alkyl or C₃-C₃₀alkenyl, including poly-or per-fluoroderivatives; R″ is R′ or H or alkylsulfonyl, R′″SO₂—, where R′″ is C₁-C₃₀alkyl or C₃-₃₀alkenyl, or its poly-or per-fluoroderivatives; or
D) Heterocyclic moiety selected from the group comprising of (tetrahydro)furfuryl, N-pyperidyl- and N-morpholyl-; or
E) Mono-, di- or oligosaccharide or its derivative; or
F) Polyol monoalkanoate,
3. R⁴ is R² or R³
4. R is R¹_{A}(R²O)_{B}(R³O)_{C}SiO—
5. R⁶ is R⁵[R¹_{D}(R⁴O)_{E}R⁵_{F}SiO]_{Z}-, wherein Z≧0;
provided that
a. the compound comprises at least one silicon atom having at least three Si—O bonds;
b. the compound comprises at least one R² radical.

2. A composition according to claim 1, wherein the amount of the silicon ester is from about 0.03% to about 20% by weight in an aqueous solution, preferably from about 0.05% to about 5%.

3. A composition according to claim 1, wherein the amount of the silicon ester is from about 20% to about 99.5% by weight in a non-aqueous solution.

4. A composition according to claim 1, comprising at least one surfactant.

5. A composition according to claim 4, wherein said surfactant is selected from the group consisting of non-ionic, amphoteric and ionic low- and high molecular weight surfactants.

6. A composition according to claim 4, wherein the amount of said surfactant is from about 0.0001 to about 6 times the amount of the silicon ester, preferably from about 0.0001 to about 2 times.

7. A composition according to claim 1, wherein said silicon ester R¹ and R³ are C₁-C₂₀alkyl or C₆aryl radicals.

8. A composition according to claim 1, wherein in said silicon ester R² is a polyoxyalkylene chain, linked an organic residue R.

9. A silicon ester as defined in claim 8, wherein said organic residue R is poly-or per-fluorosubstituted C₁-C₃₀alkyl, C₃-C₃₀alkenyl or C₇-C₃₀aralkyl.

10. A silicon ester as defined in claim 8, wherein said organic residue R is aminyl R′R″NCH₂CH₂—, where R′ is C₁-C₃₀alkyl or C₁-C₃₀alkenyl, including poly- or per-fluoroderivatives; R″ is R′ or H or alkylsulfonyl, R′″SO₂—, where R′″ is C₁-C₃₀ alkyl or C₃-C₃₀alkenyl or its poly-(or per)fluoroderivatives.

11. A silicon ester as defined in claim 8, wherein said organic residue R is a heterocyclic moiety such as (tetrahydro)furfuryl-, and N-pyperidyl-, and N-morpholyl-.

12. A silicon ester as defined in claim 8, wherein said organic residue R is a mono-, di-or oligosaccharide or its derivatives.

13. A silicon ester according to claim 12 wherein said oligosaccharide is alkylglycoside or alkanoate.

14. A silicon ester as defined in claim 8, wherein said organic residue R is polyol monoalkanoate.

15. A silicon ester as defined in claim 14 wherein said polyol monoalkanoate is anhydrosorbitane monoalkanoate.

16. A silicon ester as defined in claim 8, having a R⁵ radical wherein said radical is R¹_{A}(R²O)_{B}(R³O)_{C}SiO—.

17. A silicon ester as defined in claim 8, having a R⁶ radical wherein said radical is R⁵[R¹_{D}(R⁴O)_{E}(R⁵)_{F}SiO]_{Z}-, wherein Z>0.

18. A process for the preparation of a silicon ester of formula (I) of claim 1, wherein a compound of general formula (II)
R′ₙX₃₋ₙSi(OSi R′ₙX₂₋ₙ)ₘX (II)
wherein n=0-2, m=0-100, X=Hal, H, OR′, NR′₂, SR′ wherein R′ is monovalent organic residue;
is reacted with an alkylpolyalkylene glycol ether of general formula (III)
R(OCₙH₂ₙ)ₘOH (III)
where R is a monovalent organic residue n is 2-4 and m is 0-20;
or with the corresponding sodium or potassium alcoholates of formula (IV):
R(OCₙH₂ₙ)ₘOM (IV)
where M=Na, K;
or with its esters of formula (V):
R(OCₙH₂ₙ)ₘOC(O)R′, (V)
where R′ is a monovalent hydrocarbon radical;
or with its 1,2-epoxy-derivatives of formula (VI):
R(OCₙH₂ₙ)ₘO(CH₂)_{X}CH(O)CH₂, (VI)
wherein x=0-4, such as alcohol alkoxylate glycidyl ethers.

19. A process according to claim 18, wherein the compound of formula (II) is selected from the group comprising of A) Silicon tetrahalides; B). Alkoxysilanes and products of their partially hydrolysis, alkylolygo-silicates with SiO₂ content more than 20%; C). Alkyl alkoxysilanes , RₙSi(OR′)₄₋ₙ; D).Hydride terminated poly(dimethylsiloxane) H[(CH₃)₂SiO]ₙSi(CH₃)H, n=1-50; E). Poly (methylhydrosiloxane) (CH₃)₃SiO [(CH₃)HSiO]ₙSi(CH₃)₃, n=1-50; F). Chlorine terminated poly(dimethylsiloxane) Cl[(CH₃)₂SiO]ₙSi(CH₃)₂Cl, n=1 -50; G).Methoxy terminated poly -(dimethylsiloxane) CH₃O[(CH₃)₂SiO]ₙSi(CH₃)₂OCH₃, n=1-50.

20. A process according to claim 18, wherein the compounds of formulae (III), (IV), (V) and (VI) are selected from the group comprising as the R radical A). Poly- or per-fluorosubstituted C₁-C₃₀alkyl or C₃-C₃₀alkenyl; or B). Alkaryl-R′R″-C₆H₃—, where R′ is C₃-C₂₀alkyl, R″═R′; or C). Nitrogen-containing radical of general formula R′R″NCH₂CH₂—, where R′ is C₁-C₃₀alkyl or C₃-C₃₀alkenyl, including poly-or per-fluoroderivatives; R″ is R′ or H or alkylsulfonyl, R′″SO₂—, where R′″ is C₁-C₃₀alkyl or C₃-C₃₀alkenyl, or its poly-or per- fluoroderivatives; or D). Heterocyclic moiety selected from the group consisting of (tetrahydro)furfuryl, N-pyperidyl- and N-morpholyl-;.or E). Mono-, di- or oligosaccharide or its derivative, preferably alkylglycoside; or F). Polyol monoalkanoate, preferably anhydrosorbitane monoalkanoate;

21. A process according to claim 18, wherein the compound of formula (III) is selected from the group comprising of poly(ethylene glycol) unhydrosorbitane monooleate, poly(ethylene glycol) methyl glucose ether, poly(propylene glycol) methyl glucose ether, poly(ethylene glycol) tallow amine ether, poly(ethylene glycol) cocamine ether, poly(ethyleneglycol) perfluoroalkyl ether, poly(ethylene glycol) tetrahydrofurfuril ether and poly(ethylene glycol)2-[ethyl heptadecafluorooctyl) sulfonyl]aminoethyl, or their sodium or potassium alcoholates, acetates or glycidyl ethers.

22. A method for controlling insects, mites, nematodes and fungi, which comprises treating insects, mites, nematodes or Fiji or an environment thereof with an effective amount of a pesticidal composition according to claim 1.
